(19) United States
(12) Patent Application Publication
(10) Pub. No.: US 2026/0236784 A1
(43) Pub. Date: Aug. 13, 2026

(54) TIME-AWARE ARTIFICIAL INTELLIGENCE AGENTS USING GENERATIVE LANGUAGE MODELS

(71) Applicant: Lonnie Eldridge

(72) Inventors: Lonnie Jackson Eldridge, San Diego, CA (US); Emil Samir Abdelshehid, Los Angeles, CA (US)

(21) Appl. No.: 19/051,907

(22) Filed: Feb. 12, 2025

(51) Int. Cl. G06N 3/091; G06N 3/0475

(52) U.S. Cl. CPC G06N 3/091; G06N 3/0475

(57) ABSTRACT

Techniques are provided for enabling autonomous agent behavior in generative language models through time-synchronized input methods. A generative language model is configured with a system prompt instructing the model to generate substantive responses at times determined by the model and null response markers when no response is needed. The system injects time values from an external clock into the context window of the model at regular intervals. A null response filter removes responses generated by the model containing the null marker and displays substantive responses to users when no null response marker is generated. The system enables precise temporal awareness by allowing the model to independently determine when to generate responses based on injected time values. Additional implementations incorporate state information comprising environmental variables and duration tracking for elapsed time measurements. This approach improves upon conventional reactive models by enabling autonomous time- and state-aware behavior while maintaining the fundamental text generation capabilities of the model.

### TECHNICAL FIELD

The present disclosure relates generally to autonomous agent systems utilizing generative language models, such as large language models (LLMs), and more particularly to techniques for enabling time-aware artificial intelligence (AI) agents through synchronized time injection methods. Specifically, the disclosure describes approaches for converting reactive generative language models into autonomous agents by providing time notations and state information at regular intervals, allowing the models to generate contextually appropriate responses based on temporal awareness. The technical field encompasses AI, machine learning, and specifically the development of agentic systems that can efficiently process time-synchronized inputs while addressing challenges in autonomous operation, temporal context management, and response timing. This field further includes methods for implementing state-aware artificial intelligence systems that can dynamically adjust their responses based on environmental variables and elapsed time measurements.

### BACKGROUND

The field of artificial intelligence (AI) has experienced transformative advancements in recent years, driven primarily by the evolution of deep learning techniques and the development of sophisticated neural networks known as large language models (LLMs). These models, which are typically based on the transformer architecture, have become the foundation of generative AI, demonstrating unparalleled capabilities in understanding, processing, and producing human-like text. Leveraging vast datasets and high-performance computing resources, LLMs are pre-trained on diverse corpora to capture intricate language patterns, enabling them to perform tasks with human-level proficiency in many cases.

LLMs have found applications across a broad spectrum of industries and use cases. In the realm of communication, LLMs power advanced chatbots and virtual assistants capable of engaging in context-aware and nuanced conversations. They are also pivotal in automating content generation, enabling the creation of coherent and contextually relevant text for marketing, entertainment, and education. Furthermore, LLMs facilitate language translation by bridging linguistic barriers with high accuracy and fluency. They are equally valuable in the summarization of complex documents, aiding users in extracting key insights from extensive textual content. These capabilities have not only enhanced productivity and efficiency but have also unlocked new possibilities in human-computer interaction, making LLMs indispensable tools in the modern AI landscape.

### BRIEF DESCRIPTION OF THE DRAWINGS

Embodiments of the present invention are illustrated by way of example and not limitation in the figures of the accompanying drawings, in which:

FIG. 1 illustrates a system architecture for enabling time-aware artificial intelligence agents through synchronized time injection, showing components for time-synchronized prompting, null response filtering, and response generation, consistent with some embodiments.

FIG. 2 illustrates an example system prompt configuring a generative language model to function as a fitness coach, showing instructions for generating time-sensitive responses and handling null response markers, consistent with some embodiments.

FIG. 3 illustrates a detailed view of internal dialog processing between a user and generative language model, showing time-synchronized prompts, null response filtering, and user interface elements, consistent with some embodiments.

FIG. 4 illustrates a system architecture incorporating state information updates with time-injected language models, showing components for managing environmental variables and state prompts, consistent with some embodiments.

FIG. 5 illustrates a system architecture incorporating duration tracking with time-injected language models, showing components for managing duration markers and duration prompts, consistent with some embodiments.

FIG. 6 illustrates a cloud-based implementation incorporating a dynamic prompt generator, duration update module, and state update module within a unified service architecture, consistent with some embodiments.

FIG. 7 illustrates a software architecture that may be installed on a machine, consistent with some embodiments.

FIG. 8 illustrates a diagrammatic representation of a machine in the form of a computer system within which instructions may be executed for causing the machine to perform any methodologies discussed herein, consistent with some embodiments.

### DETAILED DESCRIPTION

Described herein are techniques for enabling autonomous agent behavior in generative language models through time-synchronized input methods. The systems and methods set forth herein enable precise temporal awareness in generative language models, and specifically large language models (LLMs), by injecting time notations at regular intervals, allowing the models to independently determine when to generate responses. Rather than relying on purely reactive prompt-response patterns, the disclosed approaches allow LLMs to function as autonomous agents by maintaining awareness of time progression and contextual state information. In the following description, numerous specific details are provided, including techniques for time injection, methods for implementing null response markers, approaches for state variable management, and systems for duration tracking. These implementations enable temporal awareness in language models while maintaining their fundamental text generation capabilities. The disclosed embodiments may be implemented using various configurations, including networked systems with external clocks or local implementations with integrated timing modules. While specific implementations are described, it will be apparent to one skilled in the art that the disclosed embodiments may be practiced with various modifications and alternative configurations while maintaining the core functionality of time-synchronized language model operation.

LLMs are a type of neural network trained on extensive corpora of text data. The training process involves exposing the model to a vast number of language samples, enabling it to learn patterns, structures, and contextual relationships within the data. Common datasets used for training LLMs include publicly available corpora, such as the Wikipedia Corpus, which contains approximately two billion words, or even larger datasets derived from a significant fraction of the internet's textual content. By training on such extensive and diverse datasets, LLMs can generalize language patterns and apply them across various domains.

The fundamental operation of an LLM involves the task of next-token prediction. When provided with an input sequence, commonly referred to as a “prompt,” the model predicts the next token—a character, word, or subword unit—that is most likely to follow, based on the context of the input. This is achieved through a feed-forward process:
1. The prompt is input into the neural network.
2. The network calculates the probability distribution of potential next tokens.
3. The token with the highest probability is selected and appended to the prompt.
4. The updated sequence (original prompt plus the generated token) is re-fed into the model.
5. This process repeats iteratively until a complete output sequence of desired length is generated.

A key characteristic of LLMs is their reliance on an immense number of parameters. These parameters, often numbering in the billions, represent learned weights within the neural network and are adjusted during the training process to optimize the model's predictive accuracy. For instance, state-of-the-art models like LLAMA 3 incorporate approximately 70 billion parameters. Each parameter plays a role in the computational process, and because a significant fraction of these parameters is engaged in generating each token, the computational demands of LLMs are substantial.

To regulate the generation process and determine when to stop, LLMs employ specific mechanisms. The most common method is the inclusion of an End of Sequence (EOS) token during training. EOS tokens are embedded in the input data at logical endpoints, such as the conclusion of a web page or a chapter in a book. When generating text, the LLM may produce an EOS token, signaling that the output is complete. Alternative stopping techniques include specifying a maximum token or word count or detecting certain keywords in the output.

The capabilities of LLMs stem from their ability to process and model complex relationships in textual data. However, their computational requirements and reliance on extensive datasets also present challenges, such as high resource consumption during training and inference. Despite these challenges, LLMs have proven to be transformative, enabling new possibilities across industries and redefining the scope of machine learning applications.

Conventional generative language models operate in a purely reactive manner, responding only when explicitly prompted by a user or system query. This reactive paradigm significantly limits their ability to function as autonomous agents that can independently determine when interaction is appropriate or necessary. While these models excel at generating contextually relevant responses to direct prompts, they lack the capability to maintain temporal awareness and make time-based decisions about when to engage with users.

A key limitation of existing implementations is their inability to remain silent or withhold responses when interaction is not contextually appropriate. Traditional language models are designed to generate output for every input prompt they receive, leading to potentially disruptive or irrelevant interactions that diminish their effectiveness as autonomous agents. This constant response pattern fails to mirror natural human interaction patterns, where silence and selective engagement are essential components of effective communication.

Current approaches to implementing agent-like behavior in language models often rely on complex orchestration systems that maintain separate state tracking and decision-making logic outside the model. These external systems must constantly prompt the model when the orchestration system decides that interaction is needed, creating inflexible interaction loops and increasing system complexity. The lack of integrated temporal awareness forces developers to implement cumbersome workarounds that fail to leverage the model's inherent understanding of time-based contexts learned during training.

Additionally, conventional implementations struggle to maintain consistent context across multiple interactions over time. Without a standardized method for injecting temporal information, models cannot effectively track the progression of events or determine appropriate moments for follow-up engagement. This limitation is particularly problematic in applications requiring ongoing interaction, such as coaching or educational scenarios, where the timing of responses is crucial for maintaining user engagement and achieving desired outcomes.

Furthermore, existing systems lack an elegant mechanism for handling scenarios where the model should remain passive. While some implementations attempt to address this through complex control logic, these approaches add unnecessary complexity and fail to utilize the model's natural language understanding capabilities for determining appropriate response timing.

Consistent with some embodiments and as described herein, systems and methods are provided for enabling autonomous agent behavior in generative language models through synchronized time injection and intelligent response filtering. The disclosed approaches transform conventional reactive language models into proactive agents by maintaining precise temporal awareness while preserving the fundamental text generation capabilities of the models.

In certain embodiments, a system includes a clock component that generates synchronized time values, which are formatted and injected into the generative language model through time-synchronized prompts at regular intervals. The system incorporates a null response marker mechanism that enables the model to explicitly indicate when it chooses not to generate a substantive response, allowing for natural periods of silence while maintaining continuous temporal awareness.

For example, in a fitness coaching implementation, the system may inject time values every fifteen minutes, allowing the model to track approaching workout sessions. When the current time is 6:00 PM and a user has scheduled a 7:00 PM yoga class, the model generates a null response marker (“XXXX”) in response to the time-synchronized prompt that indicates the current time is 6:00 PM, but may generate a reminder message at 6:45 PM saying “Your yoga class starts in 15 minutes-don't forget to bring your mat!” This demonstrates how the time-synchronized prompts enable the model to maintain temporal awareness and generate contextually appropriate responses.

The system may include a state update module that provides environmental variables to enhance the contextual awareness of the generative language model. These state variables can represent various types of information, such as weather conditions, user location, or activity data. The state information may be obtained through various sources including motion sensors and environment sensors of connected devices, biometric sensors, position tracking components, and external data services accessed through the network. The data can be collected from mobile devices, wearable devices, smart home systems, third-party applications, and networked services that provide environmental and contextual information. The state information may be provided to the model either through dedicated state prompts generated by a prompt generator of the state update module, or alternatively, incorporated directly into the time-synchronized prompts that are sent to the model at regular intervals. When included in time-synchronized prompts, the state information is combined with the current time value to create comprehensive context updates at each fixed interval. The state information is maintained alongside time-synchronized prompts, enabling the model to generate responses based on both temporal and environmental context.

For instance, when a user has scheduled an outdoor run, the state update module receives weather data from environment sensors and formats it into a state prompt that includes both the current time and weather conditions. The time-synchronized prompt may take the form: “Time: Tuesday, Nov. 14, 2024, 7:00 PM; State: [weather: thunderstorm approaching; temperature: 65 F; precipitation: 90% chance]”. When this combined time and state prompt is provided to the generative language model's context window, the model can evaluate both the temporal proximity to the scheduled run and the deteriorating weather conditions. Based on this comprehensive context, the model determines a substantive response is warranted and generates the message: “I notice there's a thunderstorm approaching. Would you like to do an indoor cardio session instead of your planned outdoor run?” Consistent with some embodiments, the state information is maintained alongside other environmental variables in the context window, allowing the model to track changing conditions and generate appropriate responses based on both the current time value and environmental context.

Additionally, some implementations incorporate a duration tracking mechanism through a duration update module. This module maintains one or more duration markers that track elapsed time from specific reference points or events. The combination of real-time clock synchronization, state awareness, and duration tracking enables sophisticated autonomous behavior where the model can independently determine appropriate times for interaction.

For example, during a workout session, the duration markers track both the overall workout duration and individual exercise segments. The model can provide timely feedback like “Great job! You've been running for 20 minutes—remember to maintain your pace for the final 10 minutes of your target duration.”

Consistent with some embodiments, the system utilizes a carefully crafted system prompt that configures the model's behavior, including instructions for processing time values, handling state information, and utilizing the null response marker. This prompt engineering approach, combined with the synchronized time injection mechanism, enables the model to function as an intelligent agent that can proactively engage with users while maintaining natural interaction patterns.

The system may be implemented in several different configurations. In one embodiment, a client application executes on a user's computing device, providing a chat-style interface for user interactions. This client application communicates with a remote service that manages the time injection, state updates, and duration tracking. The remote service then interfaces with a third-party hosted generative language model, creating a three-tier architecture. In a second configuration, the service components—including the clock, state update module, and duration update module—are integrated directly into the client application. This implementation only requires remote communication with the generative language model, reducing network latency and dependencies. In a third configuration, a smaller, fine-tuned generative language model with fewer parameters operates locally on the user's computing device, whether it's a mobile device or desktop computer. This configuration includes all components running locally, enabling fully autonomous operation without network connectivity requirements. Other aspects and advantages of the several embodiments of the innovative techniques will be readily apparent from the detailed descriptions of the several figures that follows.

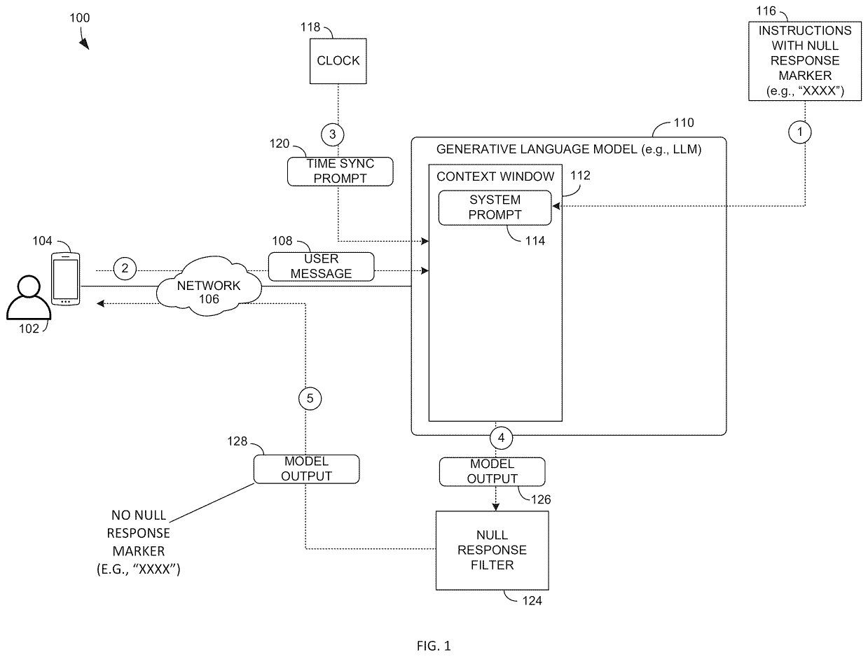

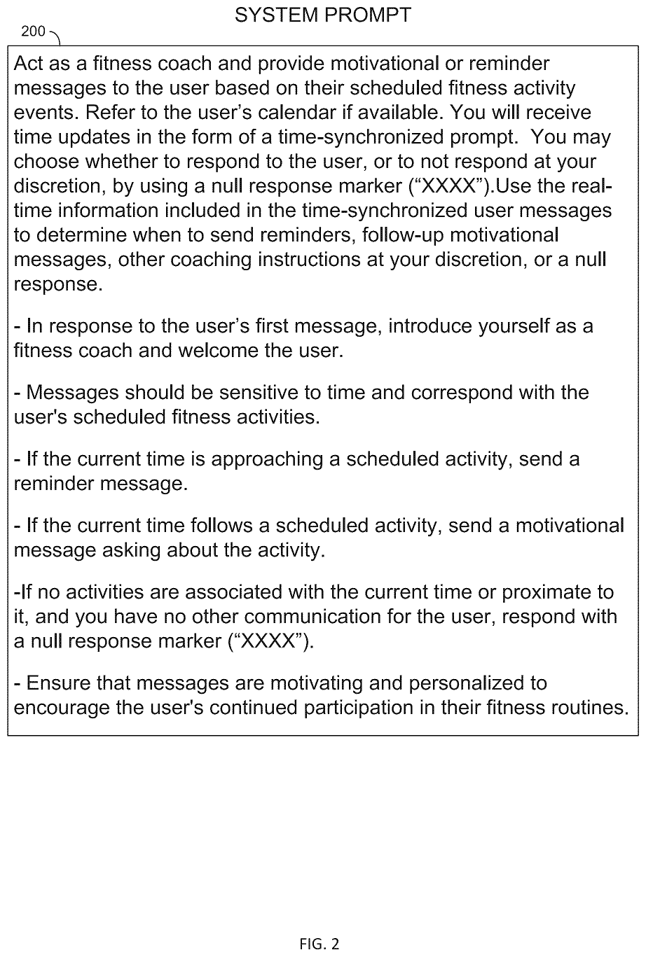

FIG. 1 illustrates a system architecture for enabling time-aware artificial intelligence agents through synchronized time injection, showing components for time prompting, null response filtering, and response generation, consistent with some embodiments. The system 100 includes several key components that work together to enable autonomous agent behavior with a generative language model 110. As shown by the reference number “1” enclosed in a circle, representing a first operation, the context window 112 of the generative language model 110 receives a system prompt 114, including instructions and the formal designation of an appropriate null response marker (e.g., “XXXX”) 116. The system prompt, detailed further in FIG. 2, configures the generative language model 110 with specific instructions for processing time values, handling user interactions, and utilizing the null response marker to enable autonomous agent behavior.

As indicated by the reference number “2” enclosed in a circle, representing a second operation, a user 102 interacts with the system through a computing device 104, sending messages 108 over a network 106 to the generative language model 110. The user's messages are incorporated into the context window 112 along with the system prompt. The user messages 108 may originate from direct user input through a chat-based interface, where users manually enter text messages to interact with the model. Alternatively, in some embodiments, the client application executing on device 104 may automatically generate and send user messages 108. For example, the application may periodically scan the user's calendar and generate messages like “User has scheduled a yoga class for Tuesday at 8:00 PM.”

The reference number “3” enclosed in a circle, representing a third operation, involves the clock component 118 providing precise time synchronization by generating time values that are formatted and injected into the generative language model 110 through a time-synchronized prompt 120. The clock 118 may be implemented using various timing mechanisms, including hardware-based clocks, network time protocols, or software-based timing services.

A time-synchronized prompt may take the form of “Time: Tuesday, Nov. 14, 2024, 8:00 PM” using a standardized date-time format. The format can be customized based on regional preferences or technical requirements, such as using ISO-8601 format (YYYY-MM-DD HH:mm:ss) or including timezone information when relevant.

The reference number “4” enclosed in a circle, representing a fourth operation, shows how the generative language model 110 processes inputs through its context window 112, which maintains the conversation history, system prompt, and time-synchronized information. For each time-synchronized prompt received at regular intervals, the model 110 evaluates the current time against any scheduled activities or ongoing interactions. Based on this temporal context, the model generates either a substantive response when interaction is appropriate, or the null response marker (“XXXX”) when no response is needed.

Finally, as shown by the reference number “5” enclosed in a circle, representing a fifth operation, the null response filter 124 receives the model's output 126 and processes it. When the model generates a response containing the null response marker, the null response filter 124 prevents that response from being transmitted back to the user. Only substantive responses (model output 128) that do not contain the null marker are forwarded through the network to the user's device 104.

This sequence of operations enables autonomous agent behavior while maintaining the fundamental text generation capabilities of the language model 110. The time injection mechanism allows the model to maintain temporal awareness without requiring modifications to its core architecture, while the null response marker provides an elegant solution for allowing the model 110 to actively choose when to respond, rather than being purely reactive.

The system can be implemented in various configurations. The clock 118 and null response filter 124 may be deployed as part of a remote service, integrated into the client application, or implemented as components of the system hosting the generative language model. This flexibility allows for different deployment scenarios while maintaining the core functionality of time-synchronized language model operation.

The architecture is particularly effective for applications requiring temporal awareness, such as scheduling assistants, fitness coaching, or educational tools, and many others. By maintaining awareness of time progression through synchronized injection of time values, the system can generate contextually appropriate responses at relevant times while remaining silent during periods when interaction is not needed.

FIG. 2 illustrates an example system prompt 200 configuring a generative language model to function as a fitness coach, showing instructions for generating time-sensitive responses and handling null response markers, consistent with some embodiments. The system prompt 200 configures the generative language model to function as an intelligent fitness coach that provides motivational messages and reminders based on the user's scheduled fitness activities. The system prompt 200 includes specific instructions for influencing the model's behavior, including how to respond to initial user messages, when to provide reminders or motivational messages, and other messages directed to the user as determined by the model, and when to generate null responses.

The system prompt directs the model to introduce itself as a fitness coach when first engaging with a user and to welcome them to the service. The prompt 200 further instructs the model to maintain temporal awareness by monitoring the current time in relation to scheduled fitness activities. When the current time approaches a scheduled activity, the model is configured to generate reminder messages to help users prepare for their upcoming fitness sessions.

Following scheduled activities, the system prompt instructs the model to generate motivational messages and inquire about the completed activity. This enables the model to provide encouragement and maintain engagement with the user's fitness journey. The prompt 200 also specifies that if no activities are temporally relevant to the current time, the model should respond with a null response marker (“XXXX”).

The system prompt 200 emphasizes the importance of personalization and motivation in the model's responses. This ensures that messages are tailored to encourage continued participation in fitness routines while maintaining a supportive and engaging tone. The prompt 200 effectively transforms the generative language model into an autonomous fitness coaching agent that can independently determine when to provide meaningful interactions based on temporal context.

This implementation demonstrates how time injection and null response markers can be practically applied to create an interactive fitness coaching experience. The system maintains awareness of scheduled activities and generates contextually appropriate responses without requiring constant user prompting, while filtering out null responses to create a natural conversation flow.

The configuration shown in FIG. 2 enables the model to function as an autonomous agent that can proactively engage with users about their fitness activities while remaining silent during periods when interaction would not be contextually appropriate. This creates a more natural and effective coaching experience compared to traditional reactive chatbot implementations.

In certain embodiments, the system prompt 200 includes foundational instructions that configure the generative language model's core behavior, including specific directives regarding the use of the null response marker (“XXXX”). The system prompt establishes the model's role, response patterns, and criteria for generating either substantive responses or null response markers based on temporal context.

However, in implementations where the system prompt 200 is preconfigured or locked by the model provider and cannot be directly modified, a separate agent prompt or initial prompt may be utilized to influence the model's behavior. This separate prompt can be injected into the context window alongside the default system prompt, providing supplementary instructions that guide the model's responses while maintaining compatibility with the base system prompt.

For example, in a fitness coaching implementation, while the system prompt may contain fundamental instructions about how to response to user messages, the separate agent prompt could provide specific guidance about:
When to generate motivational messages
How to interpret time values in relation to scheduled activities
Criteria for determining when to use the null response marker
Personalization preferences for user interactions

This dual-prompt approach provides flexibility in cases where direct modification of the system prompt is not possible, while still enabling the desired autonomous agent behavior through the combination of the base system prompt and supplementary agent prompt instructions.

A dynamic prompt generator can facilitate this approach by generating appropriate agent prompts that work in conjunction with the existing system prompt, allowing for customization of the model's behavior without requiring modifications to the core system prompt.

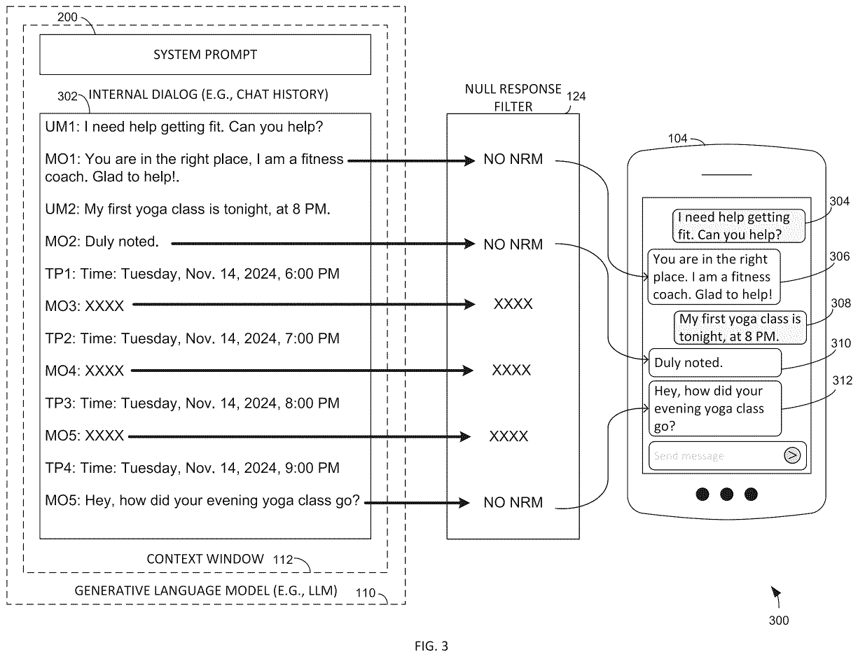

FIG. 3 illustrates a detailed example implementation showing the internal dialog processing and user interface elements of a time-injected language model system 300, demonstrating how null response filtering creates a natural conversation flow, consistent with some embodiments. The system includes a generative language model 110 with a context window 112 that maintains the internal dialog 302, which comprises a chronological sequence of user messages (UM), model outputs (MO), and time-synchronized prompts (TP). The context window preserves the complete conversation history, including both visible messages and filtered responses.

In this example, the internal dialog begins with a user message (UM1) requesting fitness assistance, followed by the model's introductory response (MO1). A second user message (UM2) provides information about an upcoming yoga class. The system then begins injecting time-synchronized prompts (TP1-TP4) at regular hourly intervals, showing timestamps in a standardized format (e.g., “Tuesday, Nov. 14, 2024, 6:00 PM”).

The null response filter 124 processes each model output, determining whether to display it in the user interface 104. When the model generates substantive responses (marked as “NO NRM”), these are passed through to the user interface and displayed in message bubbles 304-312. However, when the model generates null response markers (“XXXX”) at 6:00 PM, 7:00 PM, and 8:00 PM, these are filtered out and not displayed to the user.

The user interface 304-312 shows the progression of the conversation as seen by the user, with each message bubble representing filtered and processed model outputs. The interface displays only the substantive exchanges: the initial help request, the model's welcome message, the user's yoga class information, and the model's follow-up question after the scheduled class time.

This implementation demonstrates how the null response filtering creates a natural conversation flow by displaying only contextually relevant responses while maintaining continuous temporal awareness through the injected time prompts. The system effectively manages both user-initiated interactions and time-based automated responses, creating a seamless experience where the model appears to independently track and respond to scheduled activities.

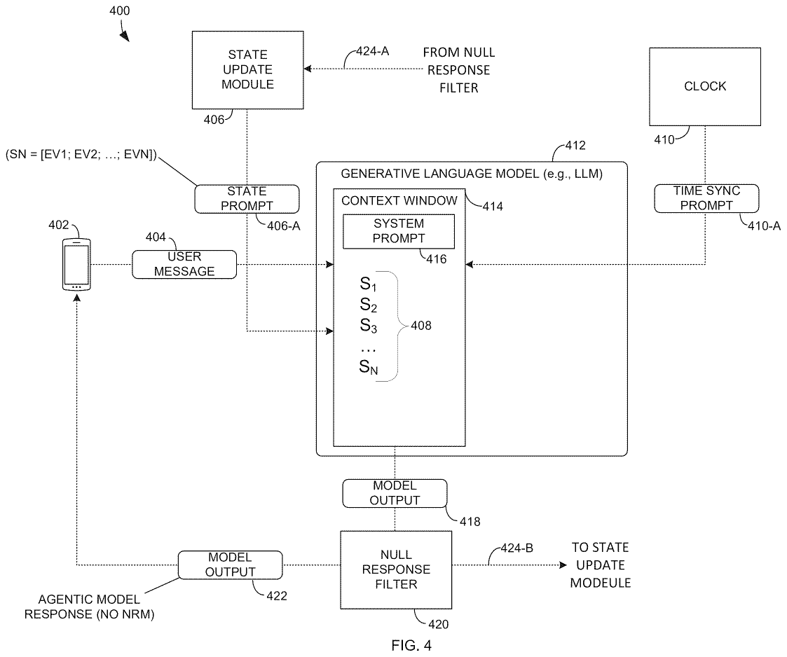

FIG. 4 illustrates a system architecture incorporating state information updates with time-injected language models, showing components for managing environmental variables and state prompts, consistent with some embodiments. The system 400 builds upon the basic architecture shown in FIG. 1 by introducing a state update module 406 that provides environmental variables to enhance the model's contextual awareness. The state update module generates state information (SN) 408 comprising multiple environmental variables (EV1, EV2, . . . , EVN) that are formatted and injected into the generative language model through a state prompt 406-A.

In certain embodiments, the state update module 406 includes a dynamic prompt generator that can generate state prompts in real-time as environmental conditions change. This allows the system to immediately provide updated state information to the generative language model as new sensor data or environmental changes are detected. Alternatively, in some implementations, the state update module 406 and clock 410 are integrated with a unified prompt generator that combines both time and state information into consolidated time-synchronized prompts. For example, at each fixed interval, the system may generate a prompt like “Time: Tuesday, Nov. 14, 2024, 7:00 PM; State: [temperature: 72 F; location: gym; activity: running]”.

A key enhancement from FIG. 1 is the context window 414 which now maintains both the system prompt 416 and a series of state variables (S1, S2, S3, . . . , SN) shown as 408. These state variables represent environmental conditions and contextual information that influence the model's decision-making process. The state information is maintained alongside the time-synchronized prompts, allowing the model to generate responses based on both temporal and environmental context.

The system prompt 416 includes specific instructions for processing state variables and generating appropriate responses. For example, the prompt may specify: “When heart rate data indicates high intensity exercise, provide encouraging messages and hydration reminders.” The model may also be configured to dynamically request state updates or modify time intervals through formatted requests like “State variable request: [heart_rate]” or “Time interval update: decrease to 30 minutes” when more frequent monitoring is needed.

The system retains the core components from FIG. 1, including the clock 410 and time sync prompt 410-A for temporal awareness, and the null response filter 420 for processing model outputs. In addition, the model output processing has been enhanced to allow the model to dynamically modify the type of state information that is received 422 through responses that also contain the null response marker (NO NRM).

This enhanced architecture enables more sophisticated autonomous behavior by allowing the model to consider both time and state information when determining when and how to respond. For example, the state variables could include weather conditions, user location, or calendar information, enabling the model to generate contextually appropriate responses based on both the current time and environmental factors.

The integration of state information represents a significant advancement over the basic time-injected architecture, as it allows the model to maintain awareness of changing environmental conditions while retaining its temporal decision-making capabilities. This combination enables more intelligent and context-aware autonomous agents that can respond appropriately based on both time and situational factors.

The system provides flexibility in implementation, allowing state variables to be dynamically updated and prioritized based on their importance to the current context. This enables the development of sophisticated autonomous agents that can adapt their behavior based on changing environmental conditions while maintaining precise temporal awareness.

In certain embodiments, the state update module 406 receives motion and acceleration data from motion components of the user's mobile device 402 or other connected devices, such as a smartwatch or fitness tracker.

The state update module 406 processes this motion data to generate environmental variables (EVs) that indicate the user's current physical activity state. For example, the module may analyze accelerometer data patterns to determine if the user is running, walking, or performing other exercise movements. This processed activity data is then formatted into state information (SN) and injected into the generative language model through the state prompt 406-A.

The context window 414 maintains both the current time from the clock 410 and the state variables 408 indicating the user's activity level. When combined with duration markers tracking elapsed exercise time, this enables the model to generate contextually appropriate responses. For instance, if the accelerometer data indicates sustained running motion for 30 minutes, the model can generate encouraging messages like “Great pace! You've been running for 30 minutes now. Remember to stay hydrated!”

The system can also detect changes in activity patterns through the motion data. If the accelerometer signals transition from high-intensity movement to low-intensity or stationary patterns, the model may generate messages like “I notice you've completed your workout. How did those 45 minutes of exercise feel? Remember to do some cool-down stretches.”

Consistent with some embodiments, environmental components may include additional sensors that provide complementary state information, such as heart rate data from a smartwatch or location data to track distance covered during exercise. This comprehensive state awareness allows the model to provide more personalized and relevant feedback based on the user's actual activity rather than just scheduled events.

This enhanced architecture demonstrates how sensor data from mobile devices can be integrated through the state update module to enable the model to track actual exercise duration and intensity, providing more intelligent and responsive coaching compared to systems that rely solely on scheduled activities.

Consistent with certain embodiments, lines 424-A and 424-B illustrate bidirectional communication between the null response filter 420 and state update module 406. The model output 418 from the generative language model 412 may be processed by the null response filter 420 and forwarded to the state update module 406 when the output contains requests for additional state information.

For example, if the generative language model 412 determines it needs updated heart rate data to provide appropriate exercise guidance, it may generate an output like “State variable request: [heart_rate]”. This output would be processed by the null response filter 420 and forwarded via line 424-A to the state update module 406, which would then retrieve and provide the requested heart rate data.

The null response filter may utilize either the standard null response marker (“XXXX”) or a dedicated state update null response marker (e.g., “STATE_XXXX”) to indicate state-related responses. For instance, when the model generates “State variable request: [heart_rate]” along with “STATE_XXXX”, this specialized marker indicates to the null response filter that this output should be forwarded to the state update module rather than filtered out completely.

This bidirectional communication enables the model to dynamically modify the type of state information it receives through responses that contain the null response marker, while maintaining the system's ability to filter out non-essential responses. The state update module can then process these requests and provide updated environmental variables through the state prompt 406-A, allowing the model to maintain current awareness of relevant state information.

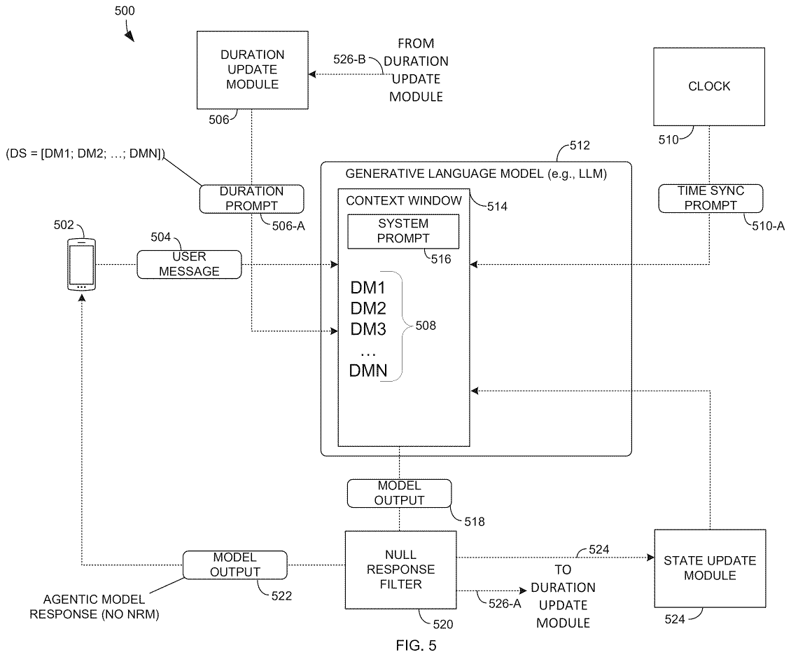

FIG. 5 illustrates a system architecture incorporating duration tracking with time-injected language models, showing components for managing duration markers and duration prompts, consistent with some embodiments. The system 500 introduces several key enhancements compared to the architectures shown in FIG. 1 and FIG. 4. While retaining the core time-injection functionality with clock 510 and time sync prompt 510-A, this implementation adds a duration update module 506 that manages duration markers (DM1, DM2, . . . , DMN) through duration prompt 506-A. The duration markers represent elapsed time measurements from specific reference points or events.

Unlike FIG. 4's state variables, the context window 514 now maintains duration markers 508 that track temporal progression from multiple reference points. These markers enable the model to understand not just the current time, but also how much time has elapsed since specific events or milestones. The system retains the null response filter 520 and can generate agentic model responses 522 that incorporate duration awareness.

The system prompt shown in FIG. 2 could be modified to incorporate duration tracking functionality by adding instructions such as:
Track and respond to duration markers for fitness activities and goals
Provide progress updates based on elapsed time since activity initiation
Generate motivational messages referencing duration-based milestones
Acknowledge and celebrate duration-based achievements
Use elapsed time information to adjust workout intensity or duration recommendations

For example, the system prompt could instruct the model to track the duration since a user began their fitness journey, individual workout sessions, or specific fitness goals. This enables the model to generate contextually appropriate responses like “Great job maintaining your workout routine for 3 weeks!” or “It's been 45 minutes since you started your run-time to cool down!”

The architecture also includes a state update module 524, demonstrating how duration tracking can be combined with environmental state information to provide comprehensive context awareness for the model's decision-making process.

In FIG. 5, the lines with reference numbers 524, 526-A and 526-B illustrate a bidirectional communication system between the null response filter 520 and both the state update module 524 and duration update module 506. The model output 518 from the generative language model 512 may be processed by the null response filter 520 and selectively routed to either module based on the type of request contained in the output.

For example, when the generative language model 512 determines it needs to modify or request a duration marker, it may generate an output like “Duration marker request: [workout_session]” along with a specialized duration null response marker (e.g., “DUR_XXXX”). Upon detecting this specialized marker, the null response filter 520 routes the request via line 526-A to the duration update module 506, which can then create or modify the appropriate duration marker.

The null response filter 520 incorporates logic to distinguish between different types of model outputs by recognizing specialized null response markers. When the model output 518 contains a standard null response marker (“XXXX”), it is filtered out completely. However, when the output contains a specialized state update marker (“STATE_XXXX”) or duration marker (“DUR_XXXX”), the null response filter 520 routes the message to the appropriate module while still preventing it from being displayed to the user.

This enhanced routing capability of the null response filter 520 enables the model 512 to dynamically manage both state information and duration tracking through specialized requests, while maintaining a clean user interface that shows only substantive responses. The bidirectional communication paths (526-B and 524) allow the respective modules to acknowledge receipt of requests and provide updated information back to the model 512 through their dedicated prompt channels (506-A and state prompts).

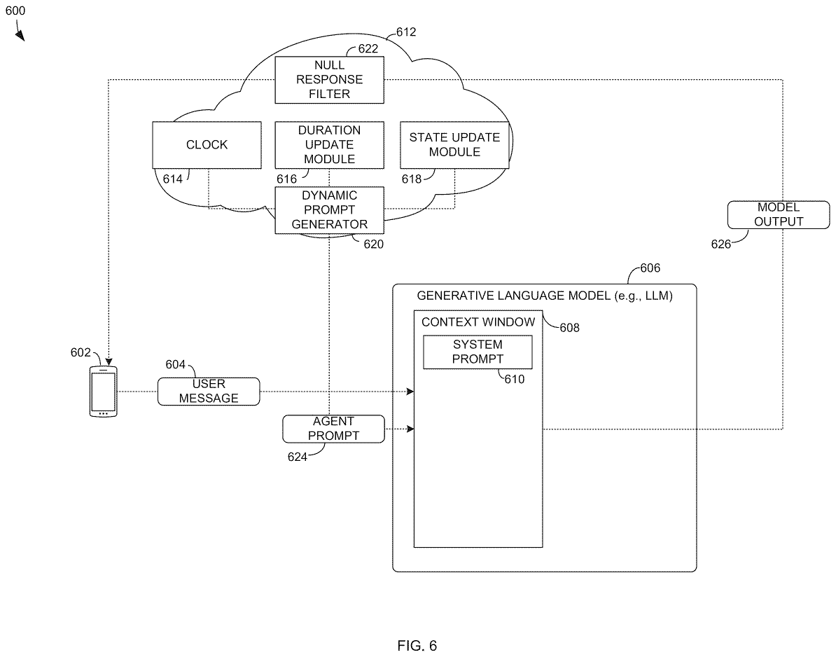

FIG. 6 illustrates a cloud-based implementation 600 of the time-injected language model system, where key components are provided as cloud services 612 that can be accessed by client applications executing on user devices 602, consistent with some embodiments.

The cloud service 612 integrates multiple components including a clock 614, duration update module 616, and state update module 618 that work together through a dynamic prompt generator 620 to provide comprehensive temporal and contextual awareness. The dynamic prompt generator 620 systematically combines data from these components to create agent prompts 624 that are sent to the generative language model 606.

In this cloud-based architecture, client applications executing on user devices 602 can leverage the service by sending user messages 604 through standard network protocols. The cloud service 612 processes these messages and maintains the temporal synchronization, state tracking, and duration monitoring needed for autonomous agent behavior. The dynamic prompt generator 620 creates properly formatted prompts that incorporate:
Current time values from the clock 614
State information about environmental conditions from the state update module 618
Duration tracking data from the duration update module 616

The cloud service 612 also includes a null response filter 622 that processes model outputs 626, ensuring that only substantive responses are returned to the client applications. This centralized architecture allows multiple client applications to benefit from the time-injection and state management capabilities without implementing these components locally.

The system provides a standardized API through which client applications can:
Send user messages and receive filtered model responses
Configure state variable monitoring
Set duration markers for tracking elapsed time
Specify time intervals for synchronization
Define custom prompt templates for specific use cases

This cloud-based implementation enables efficient scaling and maintenance of the time-injection services while allowing client applications to remain lightweight, only needing to implement the user interface and communication components necessary to interact with the cloud service.

Consistent with some embodiments, a session orchestration service (not shown) maintains conversation sessions between multiple input sources and a generative language model while preserving temporal and contextual coherence. The session orchestration service associates each conversation with a unique session identifier and manages the sequencing of prompts from different components to maintain a coherent dialog context. This orchestration enables the model to process multiple types of inputs while preserving the contextual relationships between user interactions, system prompts, and automated updates.

In the basic architecture shown in FIG. 1, the session orchestration service coordinates the flow of information between the user messages 108 sent from the client device 104, the time-synchronized prompts 120 generated by the clock 118, and the system prompt 114 with its associated instructions 116. The service ensures all of these inputs are properly sequenced and maintained within the model's context window 112, allowing the model to generate contextually appropriate responses while preserving the temporal relationships between different types of prompts.

For implementations incorporating state awareness as illustrated in FIG. 4, the session orchestration service expands its coordination role to manage both state prompts 406-A from the state update module 406 and the ongoing stream of environmental variable updates (S1-SN) 408. The service maintains conversation continuity by associating all state-related prompts with the unique session identifier, enabling the model to track changing environmental conditions while preserving the broader conversation context.

In the duration-tracking implementation shown in FIG. 5, the orchestration service manages a complex interplay of duration prompts 506-A from the duration update module 506, duration marker updates (DM1-DMN) 508, and supplementary state information from module 524. The service ensures all of these temporal tracking elements remain properly synchronized within the same conversation context, enabling the model to generate responses that accurately reflect elapsed time measurements while maintaining awareness of other contextual factors.

The cloud-based architecture depicted in FIG. 6 demonstrates how the session orchestration service can operate as part of a comprehensive cloud service 612, managing the coordination between user messages 604 from client devices 602, agent prompts 624 generated by the dynamic prompt generator 620, and the various time, state, and duration updates produced by modules 614, 618, and 616. This cloud-based implementation provides a unified conversation interface through the session identifier while handling the increased complexity of distributed components.

This sophisticated orchestration enables multiple system components to contribute contextual information to the same conversation while maintaining proper sequencing and temporal awareness. The service's ability to coordinate inputs across different deployment architectures—whether components are deployed locally, in a distributed configuration, or as cloud services—ensures consistent and coherent model responses regardless of the system's physical implementation.

While the fitness coaching implementation demonstrates one application of the time-injected language model system, the techniques described enable autonomous agent behavior across a wide range of use cases. The system's ability to maintain temporal awareness while processing both state information and duration markers makes it particularly well-suited for applications requiring ongoing interaction and contextual responses.

In the educational domain, the system can function as an intelligent tutor and study coach by leveraging its temporal awareness capabilities. The system prompt configures the generative language model to track academic schedules, monitor learning progress, and provide personalized support. For example, the system prompt may specify: “You are an educational coach helping students maintain consistent study habits and meet academic goals. Monitor scheduled study sessions and assignment deadlines. Provide encouraging reminders before study periods, check in during sessions to maintain focus, and follow up afterward to assess progress. Adjust support levels based on the student's engagement and comprehension signals.”

The state update module enhances the educational implementation by tracking critical contextual information through environmental variables. These variables include the current subject being studied, time invested across different topics, assignment completion status, and various performance metrics. The system can process this state information alongside temporal data to generate highly relevant responses. For instance, if the state variables indicate extended focus on a challenging topic, the model might generate a message suggesting: “I notice you've been working on calculus for 90 minutes—would you like to take a short break or switch to reviewing the concepts you found most difficult?”

In the project management domain, the system serves as an intelligent coordinator by maintaining awareness of multiple project timelines, dependencies, and team member activities. The system prompt configures the model to monitor project milestones, track task progress, and facilitate team coordination. A typical prompt might specify: “You are a project management assistant responsible for keeping team members aligned with project goals. Monitor task deadlines and dependencies, provide timely status updates, and proactively identify potential bottlenecks. Generate reminders before key milestones and follow up on task completion to maintain project momentum.”

The project management implementation leverages state variables to track critical project metrics including current phase status, resource allocation, team member availability, and risk factors. By combining this state information with temporal awareness, the system can generate contextually appropriate responses. For example, when approaching a milestone deadline, the system might analyze team availability and task dependencies to suggest: “The code review milestone is due tomorrow, but I notice two key reviewers are scheduled for other meetings. Should we adjust the timeline or redistribute the review tasks?”

The system's architecture provides several key advantages across these implementations. The temporal intelligence enables precise interaction timing based on real-world schedules while maintaining long-term awareness of activities and progress. The contextual awareness, powered by state variables and duration tracking, allows the system to adapt responses based on changing conditions. The flexible architecture supports both cloud-based deployment for scalability and local implementation for privacy-sensitive applications.

The enhanced user experience stems from the system's ability to maintain natural conversation patterns through selective response filtering, provide proactive assistance without constant user prompting, and deliver personalized support based on comprehensive context awareness. This combination of capabilities enables the development of sophisticated autonomous agents that can effectively support users across diverse domains while maintaining appropriate and timely interactions.

### Software Architecture

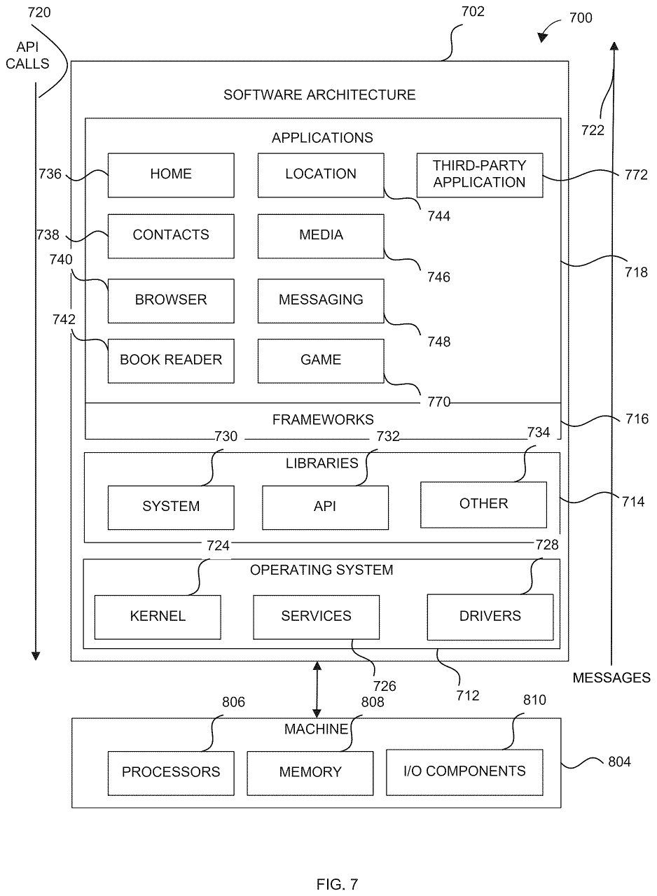

FIG. 7 is a block diagram 700 illustrating a software architecture 702, which can be installed on any one or more of the devices described herein. The software architecture 702 is supported by hardware such as a machine 804 that includes processors 806, memory 808, and I/O components 810. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematical functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

### Machine Architecture

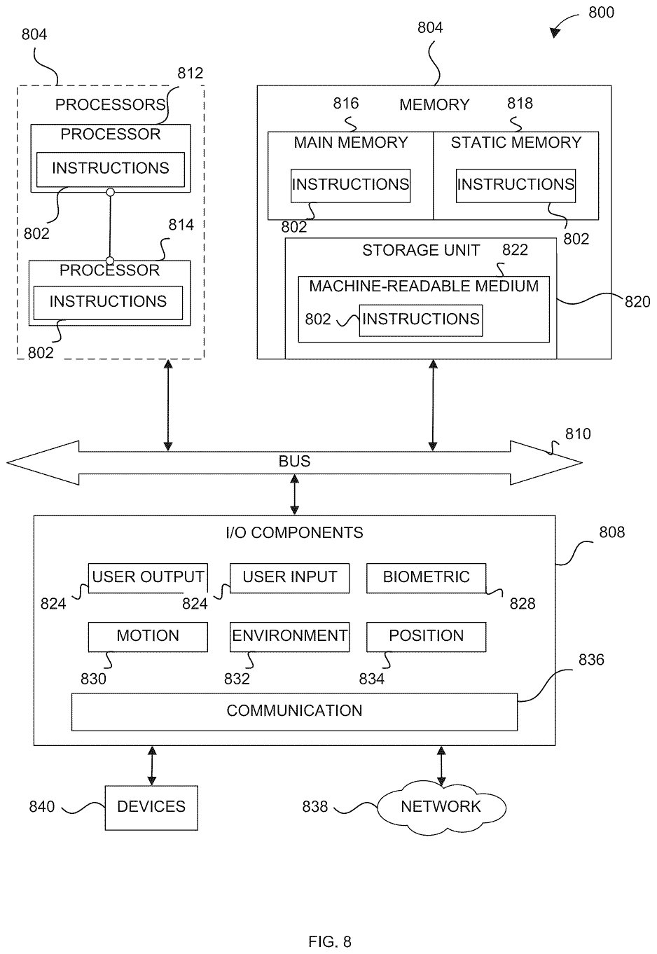

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise the user device or any one of multiple server devices forming part of a server system. In some examples, the machine 800 may also comprise both client and server systems, with certain operations of a particular method or algorithm being performed on the server-side and with certain operations of the method or algorithm being performed on the client-side.

The machine 800 may include processors 804, memory 804, and input/output I/O components 808, which may be configured to communicate with each other via a bus 810.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 624 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 830 include acceleration sensor components (e.g., accelerometer), gravitation sensor components, rotation sensor components (e.g., gyroscope).

The environmental components 832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 840.

1. A method comprising:
providing as input to a generative language model an initial prompt directing the generative language model to generate responses to subsequently received time-synchronized prompts, wherein the responses comprise either a substantive response or a null response marker when the generative language model determines not to provide a substantive response;
repeatedly, at regular intervals:
obtaining a current time value from a clock synchronized with real time,
providing the current time value to the generative language model via a time-synchronized prompt,
receiving a given response from the generative language model,
determining whether the given response includes the null response marker,
when the given response does not include the null response marker, providing the given response to an application executing on a computing device of a user, and
when the given response includes the null response marker, filtering the given response by a null response filter to prevent the given response from being provided to an application executing on a computing device of a user;
wherein the generative language model determines whether to generate a substantive response or the null response marker based on the current time value received via the time-synchronized prompt.

2. The method of claim 1, wherein the time-synchronized prompt comprises:
a text string generated by a clock-integrated prompt generator, the text string comprising one or more of:
a current date value expressed in a standardized date format,
the current time value expressed in a standardized time format, and
wherein the current date value and current time value are obtained from the clock synchronized with real time.

3. The method of claim 2, wherein the standardized date format and standardized time format are specified in the initial prompt to enable the generative language model to parse and process the current date and time for determining whether to generate a response comprising a substantive response or comprising the null response marker.

4. The method of claim 1, wherein the regular intervals comprise configurable time periods, and the generative language model is instructed via the initial prompt to dynamically request a change to a currently configured time period upon determining a condition requiring more frequent or less frequent monitoring based on information received via one or more user prompts or time-synchronized prompts.

5. The method of claim 4, wherein the condition is determined based on data received via the time-synchronized prompt, the data comprising one or more of:
motion sensor data indicating sustained high-intensity physical activity;
biometric sensor data indicating elevated heart rate measurements;
calendar data indicating upcoming scheduled activities or events; or
environmental sensor data indicating changed ambient conditions.

6. The method of claim 1, further comprising:
providing to the generative language model a user prompt specifying one or more planned activities or events, each planned activity or event expressed with an associated time or time period; and
receiving as output from the generative language model a context-appropriate substantive response generated based in part on a comparison of the current time value to the associated time or time period of a planned activity or event.

7. The method of claim 1, wherein the generative language model receives state information comprising one or more environmental variables from a state update service, and the state information is provided to the generative language model via the time-synchronized prompt together with the current time value; and
the generative language model determines whether to generate the substantive response based on both the current time value and the state information.

8. The method of claim 7, wherein the state information includes calendar information for the user;
the one or more environmental variables include at least one of: weather conditions, temperature, location information, or user activity data; and
the generative language model generates context-appropriate responses based on the calendar information and environmental variables related to the current time value.

9. The method of claim 1, wherein the generative language model receives duration information from a duration update module, the duration information provided to the generative language model via the time-synchronized prompt together with the current time value;
the duration information comprises one or more duration markers, each duration marker tracking an elapsed time from a corresponding reference time point; and
the generative language model determines whether to generate the substantive response based on both the current time value and an elapsed time indicated by the one or more duration markers.

10. The method of claim 9, wherein a first duration marker expresses an elapsed time from the beginning of an event or activity expressed in a user prompt previously provided to as input to the generative language model; and
the generative language model generates a progress-related response based on the elapsed time indicated by the first duration marker.

11. The method of claim 1, wherein the time-synchronized prompt includes:
state information comprising one or more environmental variables obtained from a state update module, and duration information comprising one or more duration markers obtained from a duration update module;
wherein i) the state information indicates current conditions associated with a user or an event or activity, ii) the duration information indicates an elapsed time from initiation of an event or activity, and iii) the generative language model determines whether to generate the substantive response based on the current time value, the state information indicating current conditions, and the duration information tracking the elapsed time.

12. The method of claim 1, wherein the clock and the null response filter are implemented as part of a remote service separate from both the generative language model and the application executing on the computing device of the user; and the remote service is configured to:
obtain the current time value from the clock at fixed time intervals;
provide the current time value to the generative language model via a time-synchronized prompt communicated over a network at the fixed time intervals;
receive a response from the generative language model for each time-synchronized prompt provided at the fixed time intervals;
filter out any response containing the null response marker; and
forward to the application any response from the generative language model that does not contain the null response marker.

13. The method of claim 1, wherein the clock and the null response filter are implemented as part of the application executing on the computing device of the user, and the application is configured to:
obtain the current time value from the clock at fixed time intervals;
provide the current time value to the generative language model via a time-synchronized prompt communicated over a network at the fixed time intervals;
receive a response from the generative language model for each time-synchronized prompt provided at the fixed time intervals;
filter out any response containing the null response marker; and
display to the user any response from the generative language model that does not contain the null response marker.

14. The method of claim 1, wherein the clock and the null response filter are implemented as integrated components of a computing system implementing the generative language model, and the computing system is configured to:
obtain the current time value from the clock at fixed time intervals;
provide the current time value to the generative language model via a time-synchronized prompt at the fixed time intervals;
receive a response from the generative language model for each time-synchronized prompt provided at the fixed time intervals;
filter out any response containing the null response marker; and
forward to the application any response from the generative language model that does not contain the null response marker.

15. The method of claim 1, further comprising:
maintaining, by a session orchestration service, a conversation session with the generative language model, the conversation session associated with a unique session identifier;
wherein the session orchestration service receives a user prompt and forwards it to the generative language model within the conversation session, receives time-synchronized prompts from a temporal context orchestrator and forwards them to the generative language model within the conversation session, and maintains conversation context across multiple prompts within the conversation session.

16. The method of claim 1, wherein the initial prompt defines a value for the null response marker and instructs the generative language model to:
monitor current time values received via time-synchronized prompts and evaluate scheduled events or activities received via user prompts,
generate substantive responses when the current time value is temporally related to a scheduled event or activity, and
generate the null response marker when the current time value is not temporally related to any scheduled event or activity.

17. The method of claim 16, wherein the initial prompt further instructs the generative language model to:
generate reminder messages when the current time value approaches a scheduled event or activity time,
generate follow-up messages when the current time value follows a scheduled event or activity time, and
generate personalized messages tailored to encourage user participation.

18. The method of claim 17, wherein the initial prompt is a system prompt.

19. A system comprising:
at least one processor; and
at least one memory storage device storing instructions thereon which, when executed by the at least one processor, cause the system to perform operations comprising:
providing as input to a generative language model an initial prompt directing the generative language model to generate responses to subsequently received time-synchronized prompts, wherein the responses comprise either a substantive response or a null response marker when the generative language model determines not to provide a substantive response;
repeatedly, at regular intervals:
obtaining a current time value from a clock synchronized with real time,
providing the current time value to the generative language model via a time-synchronized prompt,
receiving a given response from the generative language model,
determining whether the given response includes the null response marker,
when the given response does not include the null response marker, providing the given response to an application executing on a computing device of a user, and
when the given response includes the null response marker, filtering the given response with a null response filter to prevent the given response from being provided an application executing on a computing device of a user;
wherein the generative language model determines whether to generate a substantive response or the null response marker based on the current time value received via the time-synchronized prompt.

20. A non-transitory computer-readable medium storing instructions which, when executed by one or more processors of a computing system, cause the computing system to perform operations comprising:
providing as input to a generative language model an initial prompt directing the generative language model to generate responses to subsequently received time-synchronized prompts, wherein the responses comprise either a substantive response or a null response marker when the generative language model determines not to provide a substantive response;
repeatedly, at regular intervals:
obtaining a current time value from a clock synchronized with real time,
providing the current time value to the generative language model via a time-synchronized prompt,
receiving a given response from the generative language model,
determining whether the given response includes the null response marker,
when the given response does not include the null response marker, providing the given response to an application executing on a computing device of a user, and
when the given response includes the null response marker, filtering the given response with a null response filter to prevent the given response from being provided to an application executing on a computing device of a user;
wherein the generative language model determines whether to generate a substantive response or the null response marker based on the current time value received via the time-synchronized prompt.
